(19) United States
(12) Patent Application Publication
(10) Pub. No.: US 2026/0066636 A1
(43) Pub. Date: Mar. 5, 2026

(54) ELECTRICAL JUNCTION BOX

(71) Applicant: Sumitomo Wiring Systems, Ltd., Yokkaichi-shi, Mie (JP)

(72) Inventor: Kiyofumi KAWAGUCHI, Yokkaichi-shi, Mie (JP)

(73) Assignee: Sumitomo Wiring Systems, Ltd., Yokkaichi-shi, Mie (JP)

(21) Appl. No.: 19/105,979

(22) PCT Filed: Aug. 14, 2023
(86) PCT No.: PCT/JP2023/029430

§ 371 Date: Feb. 24, 2025

(30) Foreign Application Priority Data
Aug. 25, 2022 (JP) 2022-134103

(51) Int. Cl. H02G 3/16; B60R 16/033; H02G 3/08

(52) U.S. Cl. CPC H02G 3/16; B60R 16/033; H02G 3/081

(57) ABSTRACT

An electrical junction box includes a case; a circuit unit; a wire harness for connecting another device with the circuit unit; a first terminal supporting a first electric wire electrically connected to the circuit unit; and a second terminal supporting a second electric wire electrically connected to the circuit unit. When a direction along one side of the first surface is defined as a left-right direction and a direction along the other side of the first surface is defined as an up-down direction, the first terminal and the second terminal are located in a first region on one side in the left-right direction with the part of the wire harness as reference, and the first terminal and the second terminal are at different positions from each other in the up-down direction in the first region.

### CROSS-REFERENCE TO RELATED APPLICATIONS

This application is the U.S. national stage of PCT/JP2023/029430 filed on Aug. 14, 2023, which claims priority of Japanese Patent Application No. JP 2022-134103 filed on Aug. 25, 2022, the contents of which are incorporated herein.

### TECHNICAL FIELD

The present disclosure relates to an electrical junction box. This application claims priority based on Japanese Application No. 2022-134103 filed on Aug. 25, 2022, and incorporates by reference all of the contents of the above-mentioned Japanese application.

### BACKGROUND

JP 2020-091261A discloses an electrical junction box having a function of distributing input current and outputting it to an external load device. The electrical junction box has a case and a bus bar provided in the case. The bus bar has a branched structure.

An electrical junction box disclosed in JP 2020-091261A has a power supply side end portion on a first surface side of a case, and a load side end portion on a second surface side opposite to the first surface side. Some electrical junction boxes have both the power supply side end portion and the load side end portion on the first surface side of the case. That is, both an input electric wire connected to a power supply device and an output electric wire connected to a load device may pass through the first surface side of the case.

FIG. 7 is a schematic diagram illustrating an internal structure of a conventional electrical junction box. An input wire harness 92 connected to the power supply device and an output wire harness 95 connected to the load device pass through a first surface 91 side of a case 90. Furthermore, an electrical junction box 100 is configured such that a first output electric wire 93 and a second output electric wire 94 respectively connected to two separate load devices pass through the first surface 91 side.

The electrical junction box 100 has a first terminal 96 that supports the first output electric wire 93, and a second terminal 97 that supports the second output electric wire 94. If a direction along one side of the first surface 91 is defined as a left right direction, the first terminal 96, a part 92a of the input wire harness 92, a part 95a of the output wire harness 95, and the second terminal 97 are arranged in a row in this order toward one side in the left-right direction. In this case, a dimension W in the left right direction of the electrical junction box 100 is large.

Therefore, an object of the present disclosure is to provide an electrical junction box that can be miniaturized.

### SUMMARY

An electrical junction box of the present disclosure includes: a case; a circuit unit provided in the case; a wire harness for electrically connecting another device outside the case with the circuit unit; a first terminal that supports a first electric wire electrically connected to the circuit unit; and a second terminal that supports a second electric wire electrically connected to the circuit unit, in which a part of the wire harness, the first terminal, and the second terminal are arranged on a first surface side of the case in the electrical junction box, and when a direction along one side of the first surface is defined as a left-right direction and a direction along the other side of the first surface is defined as an up-down direction, the first terminal and the second terminal are located in a first region on one side in the left-right direction with the part of the wire harness as reference, and the first terminal and the second terminal are at different positions from each other in the up-down direction in the first region.

### Advantageous Effects

According to the present disclosure, it is possible to miniaturize the electrical junction box.

### BRIEF DESCRIPTION OF DRAWINGS

FIG. 1 is a perspective view of an electrical junction box.

FIG. 2 is a perspective view of the electrical junction box (with a cover removed).

FIG. 3 is a perspective view of the electrical junction box illustrated in FIG. 2 when viewed from a different direction.

FIG. 4 is a front view of the electrical junction box with the cover removed.

FIG. 5 is a plan view of the electrical junction box with the cover removed.

FIG. 6 is an enlarged perspective view of a first terminal and a second terminal.

FIG. 7 is a schematic diagram illustrating an internal structure of a conventional electrical junction box.

### DETAILED DESCRIPTION OF PREFERRED EMBODIMENTS

Hereinafter, an overview of embodiments of the present disclosure will be listed and described.

In a first aspect, an electrical junction box of the present embodiment includes: a case; a circuit unit provided in the case; a wire harness for electrically connecting another device outside the case with the circuit unit; a first terminal that supports a first electric wire electrically connected to the circuit unit; and a second terminal that supports a second electric wire electrically connected to the circuit unit, in which a part of the wire harness, the first terminal, and the second terminal are arranged on a first surface side of the case in the electrical junction box, and when a direction along one side of the first surface is defined as a left right direction and a direction along the other side of the first surface is defined as an up-down direction, the first terminal and the second terminal are located in a first region on one side in the left-right direction with the part of the wire harness as reference, and the first terminal and the second terminal are at different positions from each other in the up-down direction in the first region.

According to the electrical junction box, the first terminal and the second terminal are concentrated and located in the first region on the one side in the left-right direction with the part of the wire harness as reference. Therefore, the electrical junction box is miniaturized in the left-right direction. Even though the first terminal and the second terminal are concentrated in the first region, the first terminal and the second terminal are at different positions from each other in the up-down direction. Therefore, interference between the first electric wire and the second electric wire is prevented.

It should be noted that “the up-down direction” and “the left-right direction” are directions defined to describe configuration of the electrical junction box, and do not mean “up-down direction (vertically up-down direction)” and “left-right direction (horizontal left-right direction)” in a state where the electrical junction box is actually mounted on, for example, a vehicle body (an overall device) of an automobile or the like.

In a second aspect, in the electrical junction box according to the first aspect, preferably, the first terminal has a first support portion that supports a plurality of the first electric wires arranged in the left right direction, the second terminal has a second support portion that supports a plurality of the second electric wires arranged in the up-down direction, and the second support portion is located closer to the part of the wire harness in the left-right direction than the first support portion.

According to the above configuration, since the second support portion supports the second electric wires arranged in the up-down direction, the second terminal is likely to be located closer to the part of the wire harness in the left right direction. The first support portion supports the first electric wires arranged in the left right direction. Therefore, a dimension in the up-down direction of the first region is smaller than when the first electric wires are arranged in the up-down direction.

In a third aspect, in the electrical junction box according to the second aspect, preferably, the first terminal has a first fixing portion that fixes the first support portion to the case, the second terminal has a second fixing portion that fixes the second support portion to the case, and the first fixing portion and the second fixing portion are at different positions from each other in the left-right direction in the first region.

According to the above configuration, for example, when the first terminal is located on one side in the up-down direction from the second terminal, the first electric wire passes through a space on the one side in the up-down direction of the second fixing portion, and it is possible to effectively utilize the space.

In a fourth aspect, in the electrical junction box according to any one of the first through the third aspects, preferably, when a direction perpendicular to the left-right direction and the up-down direction is defined as a front-rear direction, the first terminal and the second terminal are at different positions from each other in the front-rear direction in the first region.

According to the above configuration, for example, when the first terminal and the second terminal are attached to the case from one side in the up-down direction, the first fixing portion of the first terminal and the second fixing portion of the second terminal do not overlap in the up-down direction, and attachment work is facilitated.

In a fifth aspect, in the electrical junction box according to the third or the fourth aspect, preferably, the case has a tray-shaped first case that is open on one side in the up-down direction, a first bolt and a second bolt protruding from the first case to the one side in the up-down direction, and a first nut and a second nut respectively fastened to the first bolt and the second bolt, and the first terminal and the second terminal are respectively fixed to the first case by the first nut and the second nut.

According to the above configuration, when the first terminal and the second terminal are attached to the first case, a fastening work of the first nut and the second nut is facilitated.

In a sixth aspect, the electrical junction box according to any one of the first through the fifth aspects, preferably includes an attachment member that supports at least one electric wire of the first electric wire and the second electric wire, and allows the one electric wire to be routed along a wall of the case.

According to the above configuration, the interference between the first electric wire and the second electric wire is prevented in the case.

Details of the embodiments of the present disclosure will be described below with reference to the drawings. Note that at least some of the embodiments described below may be combined in any manner.

### Overall Structure of Electrical Junction Box

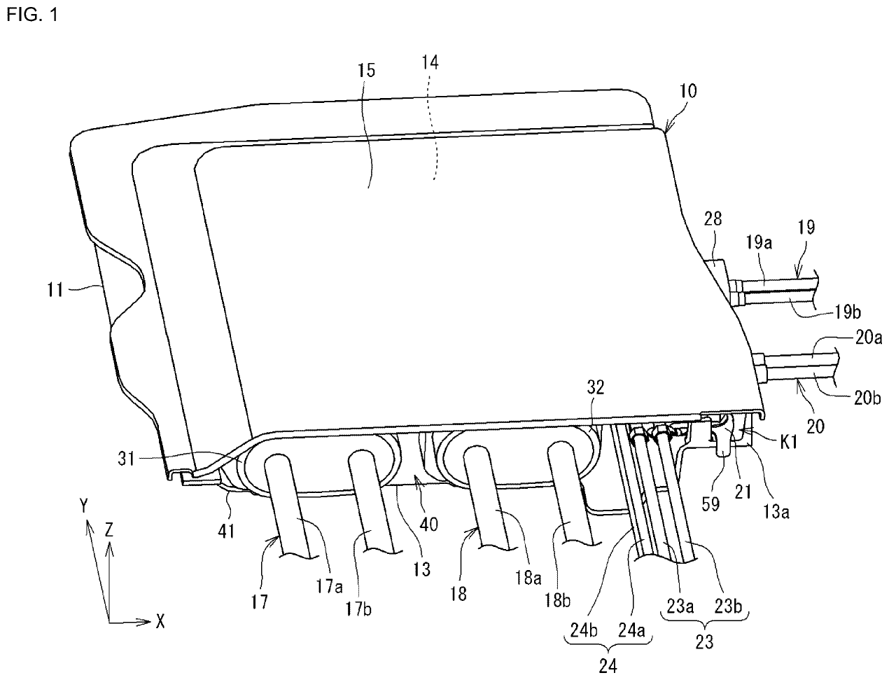

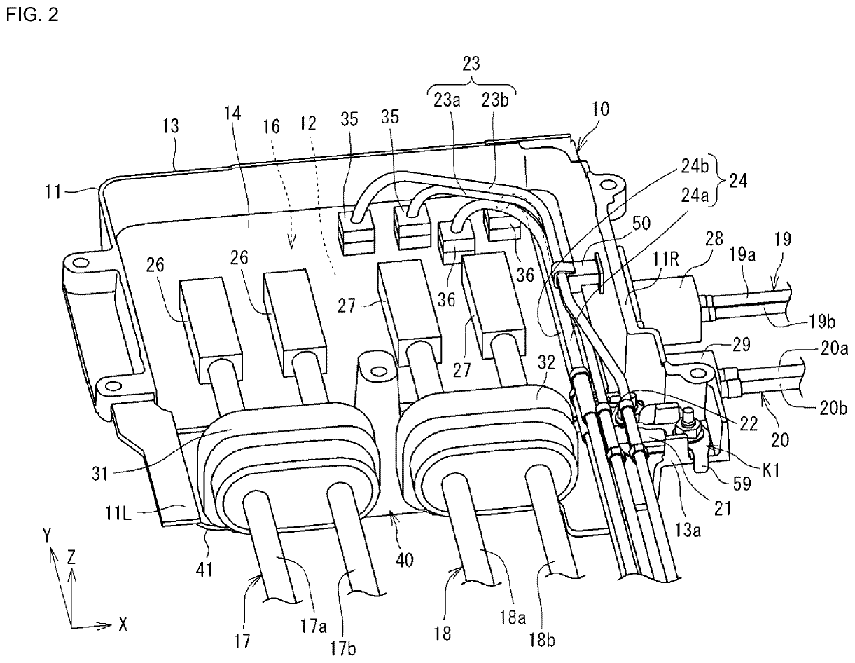

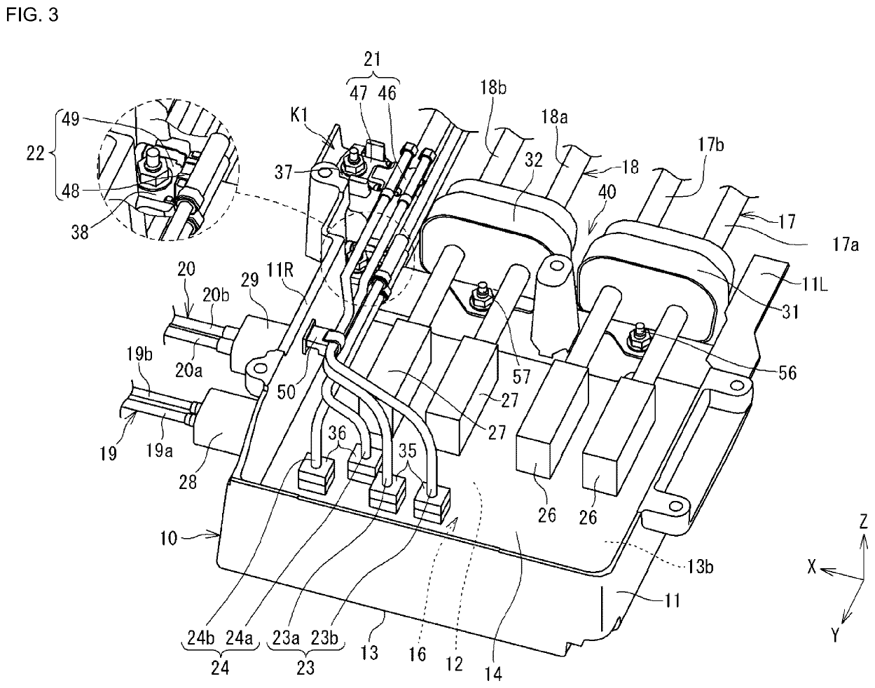

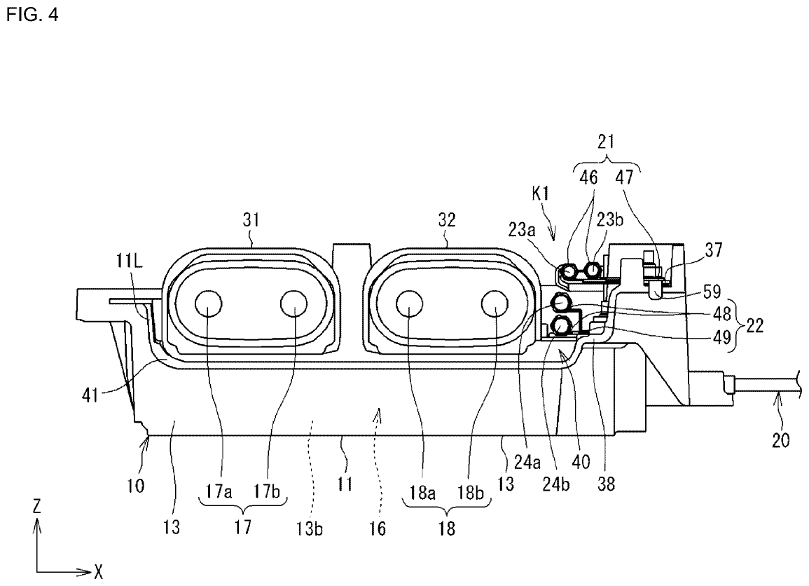

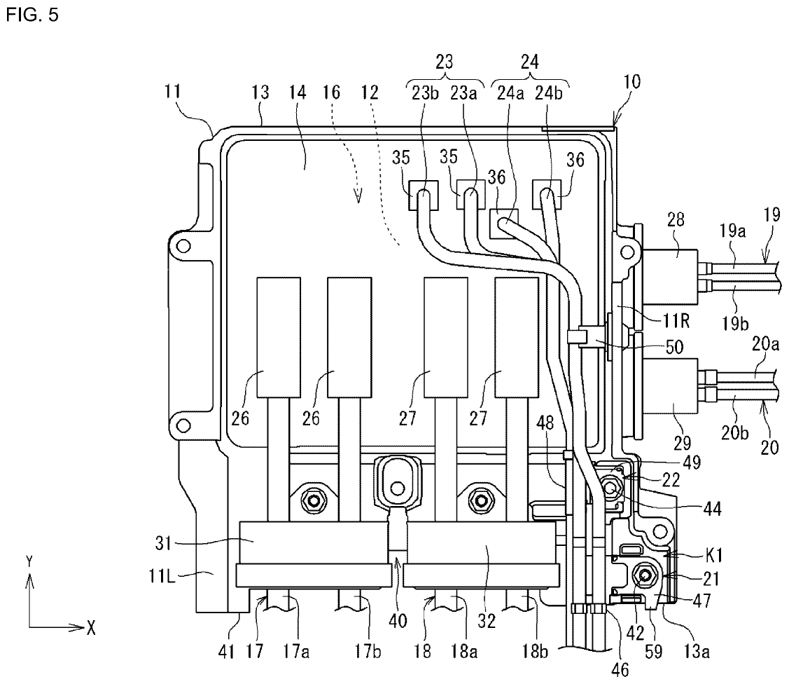

FIGS. 1 and 2 are perspective views of an electrical junction box 10. FIG. 2 illustrates the electrical junction box 10 with a cover 15 removed. FIG. 3 is a perspective view of the electrical junction box 10 illustrated in FIG. 2 when viewed from a different direction. FIG. 4 is a front view of the electrical junction box 10 with the cover 15 removed. FIG. 5 is a plan view of the electrical junction box 10 with the cover 15 removed.

The electrical junction box 10 of the present embodiment has a function of distributing input current and outputting it to an external load device, and is also called a branch box. The electrical junction box 10 has a case 11 and a circuit unit 16 provided in the case 11. The circuit unit 16 has a plurality of bus bars 12. The plurality of bus bars 12 form a branched structure for a conductive path. The electrical junction box 10 is mounted on, for example, an automobile such as an electric automobile or a hybrid automobile, and distributes battery power to a plurality of on-board devices.

### Case 11

A direction of the electrical junction box 10 will be defined later, but the case 11 has a flat box shape with a smaller dimension in the up-down direction (Z direction) than those of the left-right direction (X direction) and the front-rear direction (Y direction). The case 11 has a first case 13, a second case 14, and a cover 15 (see FIG. 1). The first case 13 has a tray shape that is open upward. The first case 13 further has a shape that is open forward. The first case 13 is made of metal member (aluminum or steel material). The first case 13 is a lower case located at a lower portion.

The second case 14 is housed in the first case 13 to be an upper case located on a bottom plate of the first case 13. A space for housing the circuit unit 16 is provided between the first case 13 and the second case 14. The second case 14 is made of an insulating member (a resin member).

The cover 15 closes an upper opening of the first case 13. The cover 15 is made of metal member (aluminum or steel material).

In a state where the cover 15 is attached to first case 13 (see FIG. 1), the case 11 has an opening 40 that is open forward. A surface of the case 11 having the opening 40 is defined as a “first surface 41”. In the present embodiment, the first surface 41 is open as a whole, and is therefore a virtual surface. Note that the first surface 41 is not necessarily open as a whole.

### Direction of Electrical Junction Box 10

A direction (having a wider width) along one side of the first surface 41 of the case 11 is defined as “left-right direction”. A direction (having a narrower width) along the other side of the first surface 41 is defined as up-down direction. A direction perpendicular to the left-right direction and the up-down direction is defined as “front-rear direction”.

Orthogonal coordinates of the X direction, the Y direction, and the Z direction are illustrated in the drawings. The left right direction is parallel to the X direction, the front-rear direction is parallel to the Y direction, and the up-down direction is parallel to the Z direction. The first surface 41 is not necessarily a precise rectangle. In the present embodiment, the first surface 41 has an uneven portion but has a long shape in one direction (the left-right direction). A longer side of a smallest rectangle virtually surrounding the first surface 41 is the “left-right direction”. A shorter side of the rectangle is the “up-down direction”.

It should be noted that the up-down direction, the left-right direction, and the front-rear direction are directions defined to describe the configuration of the electrical junction box 10, and do not mean the “up-down direction (vertical up-down direction)”, the “left-right direction (horizontal left-right direction)”, and the “front-rear direction (horizontal front-rear direction)” in a state where the electrical junction box 10 is actually mounted on the vehicle body of an automobile or the like.

### Circuit Unit 16

In FIG. 2, the circuit unit 16 including the bus bar 12 is provided in the case 11. The circuit unit 16 includes a plurality of the bus bars 12 forming a branch circuit, and also includes an overcurrent interrupting element (a fuse), a circuit board, and the like, although not illustrated. The circuit unit 16 is provided between the first case 13 and the second case 14.

### Wire Harnesses and the Like

The electrical junction box 10 is equipped with a wire harness for electrically connecting another device outside the case 11 with the circuit unit 16. The electrical junction box 10 of the present embodiment has a first wire harness 17 and a second wire harness 18 as the wire harness. The first wire harness 17 is an input wire harness electrically connected to a power supply device (battery) not illustrated. The second wire harness 18 is an output wire harness electrically connected to a load device (motor). The first wire harness 17 and the second wire harness 18 are for high voltage use.

The first wire harness 17 has two positive and negative electric wires 17a and 17b, a first connector 26, and a first shield shell 31 made of metal. The electric wires 17a and 17b are connected to the circuit unit 16 through the first connector 26. The second wire harness 18 has two positive and negative electric wires 18a and 18b, a second connector 27, and a second shield shell 32 made of metal. The electric wires 18a and 18b are connected to the circuit unit 16 through the second connector 27. As illustrated in FIG. 3, the first shield shell 31 is fixed to the case 11 (first case 13) with a fixing bolt 56 and a nut, and the first wire harness 17 is fixed to the case 11. The second shield shell 32 is fixed to the case 11 (first case 13) with a fixing bolt 57 and a nut, and the second wire harness 18 is fixed to the case 11.

Examples of the other device outside the case 11 include load devices such as an air conditioner, a heater, and a control unit, in addition to the battery and the motor.

The electrical junction box 10 further includes a third wire harness 19 and a fourth wire harness 20. The third wire harness 19 and the fourth wire harness 20 are each connected to another load device (the air conditioner, the heater, or the like) outside the case 11. The third wire harness 19 has two positive and negative electric wires 19a and 19b and a third connector 28. The electric wires 19a and 19b are fixed to the case 11 (first case 13) by the third connector 28 and are electrically connected to the circuit unit 16. The fourth wire harness 20 has two positive and negative electric wires 20a and 20b and a fourth connector 29. The electric wires 20a and 20b are fixed to the case 11 (first case 13) by the fourth connector 29 and are electrically connected to the circuit unit 16. The third wire harness 19 and the fourth wire harness 20 are for low voltage use.

### First Terminal 21 and Second Terminal 22

The electrical junction box 10 has a first terminal 21 and a second terminal 22 (see FIGS. 2 and 3). The first terminal 21 supports a first electric wire 23 electrically connected to the circuit unit 16. The second terminal 22 supports a second electric wire 24 electrically connected to the circuit unit 16.

The first electric wire 23 is an electric wire for outputting power from the circuit unit 16 to yet another load device (such as a first control unit) outside the case 11. The first electric wire 23 has two positive and negative electric wires 23a and 23b and a fifth connector 35. The fifth connector 35 is attached to the second case 14, and the electric wires 23a and 23b are electrically connected to the circuit unit 16.

The second electric wire 24 is an electric wire for outputting power from the circuit unit 16 to yet another load device (such as a second control unit) outside the case 11. The second electric wire 24 has two positive and negative electric wires 24a and 24b and a sixth connector 36. The sixth connector 36 is attached to the second case 14, and the electric wires 24a and 24b are electrically connected to the circuit unit 16.

The first electric wire 23 and the second electric wire 24 are for low voltage use.

The first electric wire 23 has a shield (not illustrated) that covers the two electric wires 23a and 23b outside the case 11. The shield is made of braided wire. The shield is electrically connected to the first terminal 21, and the first terminal 21 also functions as an earth terminal.

The second electric wire 24 has a shield (not illustrated) that covers the two electric wires 24a and 24b outside the case 11. The shield is made of braided wire. The shield is electrically connected to the second terminal 22, and the second terminal 22 also functions as an earth terminal.

### Electrical Junction Box 10

With the above configuration, the current input from the first wire harness 17 to the electrical junction box 10 is distributed through the second wire harness 18, the third wire harness 19, the fourth wire harness 20, the first electric wire 23, and the second electric wire 24, and is output to a plurality of load devices.

The first shield shell 31 and the second shield shell 32 are arranged on the first surface 41 which is a front side of the case 11. The first wire harness 17 and the second wire harness 18 pass through the first surface 41 which is the front side of the case 11 in the front-rear direction.

The first terminal 21 and the second terminal 22 are arranged on the first surface 41 side which is the front side of the case 11. The first electric wire 23 and the second electric wire 24 pass through the first surface 41 which is the front side of the case 11 in the front-rear direction.

In the case of the electrical junction box 10 of the present embodiment (see FIGS. 2 and 5), the first shield shell 31 which is a part of the first wire harness 17, the second shield shell 32 which is a part of the second wire harness 18, the first terminal 21, and the second terminal 22 are arranged closer to the first surface 41 side (that is, the front side) of the case 11.

The first terminal 21 and the second terminal 22 are concentrated and arranged in a first region K1 on one side in the left-right direction (right side in FIGS. 2 and 5). More specifically, the first terminal 21 and the second terminal 22 are located in the first region K1 on the one side in the left-right direction with the part (first shield shell 31) of the first wire harness 17 and the part (second shield shell 32) of the second wire harness 18 as references. The first shield shell 31, which is located on the other side in the left-right direction (left side in FIGS. 2 and 5), is close to a part (a left side wall 11L) of the case 11. No electric wire or terminal that supports the electric wire is located between the first shield shell 31 and the side wall 11L.

### Arrangement of First Terminal 21 and Second Terminal 22

As illustrated in FIG. 4, the first terminal 21 is located above the second terminal 22. As illustrated in FIG. 3, the case 11 (first case 13) has, in the first region K1, a first bottom 37 for attaching the first terminal 21 and a second bottom 38 for attaching the second terminal 22. The first bottom 37 rises above the second bottom 38. The first bottom 37 and the second bottom 38 are provided as separate regions in the front-rear direction. A space (the first bottom 37) where the first terminal 21 is attached and a space (the second bottom 38) where the second terminal 22 is attached are both secured.

The second bottom 38 is a portion that rises above a bottom plate 13b of the first case 13 on which the circuit unit 16 is provided. The second bottom 38 is located above the second case 14. The first terminal 21 is attached to the first bottom 37, and the second terminal 22 is attached to the second bottom 38. Thus, the first terminal 21 and the second terminal 22 are at different positions from each other in the up-down direction in the first region K1.

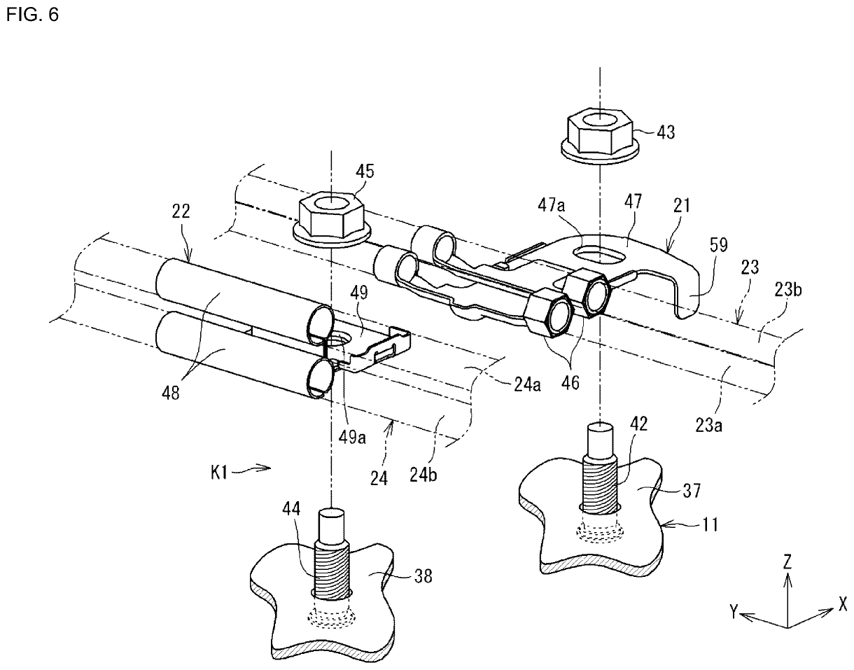

FIG. 6 is an enlarged perspective view of the first terminal 21 and the second terminal 22. The case 11 has, in the first region K1, a first bolt 42 that protrudes upward and is attached to the first bottom 37. The case 11 has a second bolt 44 that protrudes upward and is attached to the second bottom 38. The case 11 has a first nut 43 that is fastened to the first bolt 42, and a second nut 45 that is fastened to the second bolt 44.

The first terminal 21 is a flag terminal. The first terminal 21 has two first support portions 46 and one first fixing portion 47. The second terminal 22 is a flag terminal. The second terminal 22 has two second support portions 48 and one second fixing portion 49. The first terminal 21 and the second terminal 22 are respectively fixed to the first case 13 by the first nut 43 and the second nut 45. The fixing structure will be described below.

The first fixing portion 47 is made of a plate piece and has a hole 47a through which the first bolt 42 passes. With the first fixing portion 47 placed on the first bottom 37 and the first bolt 42 passing through the hole 47a, the first nut 43 is fastened to the first bolt 42. This fixes the first fixing portion 47 to the first bottom 37. As the one first fixing portion 47 and the two first support portions 46 are integrated, the first support portion 46 is fixed to the case 11 (first bottom 37) by the first fixing portion 47.

The first terminal 21 has a stopper portion 59. The stopper portion 59 is a portion that extends downward from a front portion of the first fixing portion 47. The stopper portion 59 is capable of contacting a front surface 13a (see FIG. 5), which is part of the case 11 (first case 13), toward the rear. The first terminal 21 is positioned by the stopper portion 59.

In FIG. 6, the second fixing portion 49 is made of a plate piece and has a hole 49a through which the second bolt 44 passes. With the second fixing portion 49 placed on the second bottom 38 and the second bolt 44 passing through the hole 49a, the second nut 45 is fastened to the second bolt 44. This fixes the second fixing portion 49 to the second bottom 38. As the one second fixing portion 49 and the two second support portions 48 are integrated, the second support portion 48 is fixed to the case 11 (second bottom 38) by the second fixing portion 49.

As illustrated in FIG. 6, the two first support portions 46 support the two electric wires 23a and 23b of the first electric wire 23 arranged in the left right direction (X direction). In contrast, the second support portion 48 supports the two electric wires 24a and 24b of the second electric wire 24 arranged in the up-down direction (Z direction). The first support portion 46 has a cylindrical portion, and through which the first electric wire 23 passes. The second support portion 48 has a cylindrical portion, and through which the second electric wire 24 passes. As illustrated in FIG. 4, the second support portion 48 is located closer to the second shield shell 32 in the left-right direction than the first support portion 46.

As illustrated in FIG. 5, the first fixing portion 47 and the second fixing portion 49 are at different positions from each other in the left-right direction (X direction) in the first region K1. More specifically, the first fixing portion 47 is located on the one side in the left-right direction (right side in FIG. 5) away from the second shield shell 32 than the second fixing portion 49.

The first terminal 21 and the second terminal 22 are at different positions from each other in the front-rear direction (Y direction) in the first region K1. More specifically, the first terminal 21 is located on the front side closer to the opening 40 than the second terminal 22.

### Arrangement of First Electric Wire 23 and Second Electric Wire 24

As illustrated in FIGS. 2, 3, and 5, the first electric wire 23 and the second electric wire 24 are arranged along a right side wall 11R of the case 11. The first electric wire 23 is located higher than the second electric wire 24 in a region along the side wall 11R. The two electric wires 23a and 23b of the first electric wire 23 are bundled together with tape (not illustrated). The two electric wires 24a and 24b of the second electric wire 24 are bundled together with tape (not illustrated).

To prevent interference between the first electric wire 23 and the second electric wire 24 in the case 11, the electrical junction box 10 includes an attachment member 50. The attachment member 50 is provided on the side wall 11R and protrudes into the case 11. In the present embodiment, the attachment member 50 supports the first electric wire 23 (two electric wires 23a and 23b). The attachment member 50 prevents the two electric wires 23a and 23b from being displaced in the up-down and left right directions.

In the present embodiment, the second electric wire 24 (two electric wires 24a and 24b) is not supported by the attachment member. However, although not illustrated, the second electric wire 24 may also be supported by the attachment member provided on the side wall 11R. That is, the attachment member 50 supports at least one of the first electric wire 23 and the second electric wire 24, and allows the one electric wire to be routed along the wall (side wall 11R) of the case 11.

### Electrical Junction Box 10 of the Present Embodiment

As described above, the electrical junction box 10 of the present embodiment includes the case 11, the circuit unit 16 provided in the case 11, the wire harnesses 17 and 18 for electrically connecting another device outside the case 11 with the circuit unit 16, the first terminal 21, and the second terminal 22. The first terminal 21 supports the first electric wire 23 that is electrically connected to the circuit unit 16. The second terminal 22 supports the second electric wire 24 that is electrically connected to the circuit unit 16. The shield shells 31 and 32 which are respectively parts of the wire harnesses 17 and 18, the first terminal 21, and the second terminal 22 are arranged on the first surface 41 side of the case 11.

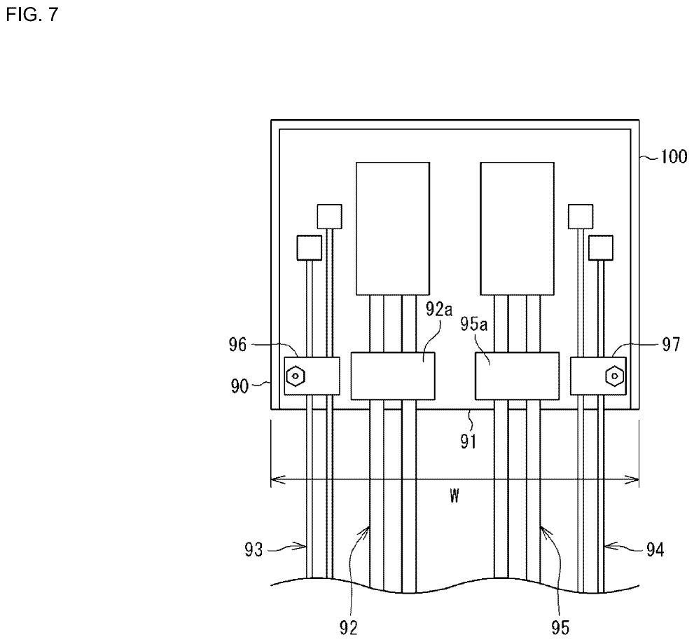

The first terminal 21 and the second terminal 22 are located in a first region K1 on the one side in the left-right direction (right side in the case of FIG. 2) with the shield shells 31 and 32 as reference. The first terminal 21 and the second terminal 22 are concentrated in the first region K1. According to the electrical junction box 10 of the present embodiment, it is possible to miniaturize the electrical junction box 10 in the left right direction compared to the conventional technology illustrated in FIG. 7. In addition, the first terminal 21 and the second terminal 22 are located at different positions from each other in the up-down direction in the first region K1. Therefore, the interference between the first electric wire 23 and the second electric wire 24 is prevented in the case 11.

As illustrated in FIG. 6, the first terminal 21 has the first support portion 46, and the first support portion 46 supports the first electric wire 23 (electric wires 23a and 23b) arranged in the left right direction. In contrast, the second terminal 22 has the second support portion 48, and the second support portion 48 supports the second electric wire 24 (electric wires 24a and 24b) arranged in the up-down direction. As illustrated in FIG. 4, the second support portion 48 is located closer to the second shield shell 32 in the left-right direction than the first support portion 46.

Since the second support portion 48 supports the second electric wire 24 (electric wires 24a and 24b) arranged in the up-down direction, the second terminal 22 is likely to be located closer to the second shield shell 32 in the left-right direction. The first support portion 46 supports the first electric wire 23 (electric wires 23a and 23b) arranged in the left right direction. Therefore, a required dimension of the first region K1 in the up-down direction is smaller than if the two electric wires 23a and 23b were arranged in the up-down direction. Therefore, it is possible to miniaturize the electrical junction box 10 in the up-down direction. Then, the first support portion 46 and the second support portion 48 are at different positions from each other in the up-down direction, and the interference between the first electric wire 23 and the second electric wire 24 is prevented.

The first terminal 21 has a first fixing portion 47 that fixes the first support portion 46 to the case 11. The second terminal 22 has the second fixing portion 49 that fixes the second support portion 48 to the case 11. As illustrated in FIG. 5, the first fixing portion 47 and the second fixing portion 49 are at different positions from each other in the left right direction in the first region K1. In the present embodiment, as described above, the first terminal 21 is located higher than the second terminal 22. With this configuration, the first electric wire 23 passes a space above the second fixing portion 49, so that the space can be effectively utilized. In addition, the first electric wire 23 (electric wires 23a and 23b) are supported by the first terminal 21 arranged in the left-right direction, which contributes to miniaturization of the electrical junction box 10 in the up-down direction.

In particular, in the present embodiment, the first terminal 21 and the second terminal 22 are both flag terminals. The case 11 has a tray shaped first case 13 that is open upward. The case 11 has the first bolt 42 and the second bolt 44 that protrude upward. The case 11 has the first nut 43 and the second nut 45 that are fastened to the first bolt 42 and the second bolt 44. The first terminal 21 (first fixing portion 47) and the second terminal 22 (second fixing portion 49) are respectively fixed to the first case 13 by the first nut 43 and the second nut 45.

In the present embodiment, the first terminal 21 and the second terminal 22 are attached to the case 11 from above. The first terminal 21 and the second terminal 22 are at different positions from each other in the front-rear direction in the first region K1. With this configuration, the space (first bottom 37) where the first terminal 21 is attached and the space (second bottom 38) where the second terminal 22 is attached are both secured. The first fixing portion 47 and the second fixing portion 49 do not overlap in the up-down direction, and attachment work is facilitated.

As described above, in the present embodiment, the first terminal 21 and the second terminal 22 are concentrated in the first region K1. The second support portion 48 closer to the second shield shell 32 supports the second electric wire 24 (two electric wires 24a and 24b) arranged in the up-down direction. In contrast, the first support portion 46 located above the second support portion 48 supports the first electric wire 23 (two electric wires 23a and 23b) arranged in the left-right direction. Furthermore, the first fixing portion 47 and the second fixing portion 49 are at different positions from each other in the left-right and up-down directions. According to the present embodiment, it is possible to miniaturize the electrical junction box 10 in the left-right and up-down directions, and further prevent interference between various portions and facilitate attachment work of the first terminal 21 and the second terminal 22 to the case 11.

### Others

In the present embodiment, the electrical junction box 10 has the second wire harness 18, but the second wire harness 18 may be omitted. In this case, the first terminal 21 and the second terminal 22 are located in the first region K1 on the one side in the left-right direction with the part (first shield shell 31) of the first wire harness 17 as reference. One or both of the third wire harness 19 and the fourth wire harness 20 may be omitted.

Although a case where the first terminal 21 is in an upper position and the second terminal 22 is in a lower position in the first region K1 has been described, the first terminal 21 may be in the lower position and the second terminal 22 may be in the upper position. That is, the first terminal 21 and the second terminal 22 only need to be at different positions from each other in the up-down direction.

In the present embodiment, the first terminal 21 and the second terminal 22 are the flag terminals but have different shapes. The first terminal 21 and the second terminal 22 may have the same shape. Although a case where the first terminal 21 and the second terminal 22 are the flag terminals has been described, they may also be terminals having other shapes.

Although a case where the electrical junction box 10 has the attachment member 50 that supports the electric wire (first electric wire 23) inside the electrical junction box 10 has been described, the attachment member 50 may be omitted.

The above-described embodiment is illustrative in all respects and is not restrictive. The scope of the present disclosure is indicated by the claims, not by the above-described embodiment, and includes all modifications within the scope of equivalents to the configurations described in the claims.

1. An electrical junction box comprising:
a case;
a circuit unit provided in the case;
a wire harness for electrically connecting another device outside the case with the circuit unit;
a first terminal that supports a first electric wire electrically connected to the circuit unit; and
a second terminal that supports a second electric wire electrically connected to the circuit unit, wherein
a part of the wire harness, the first terminal, and the second terminal are arranged on a first surface side of the case in the electrical junction box, and
when a direction along one side of the first surface is defined as a left-right direction and a direction along the other side of the first surface is defined as an up-down direction,
the first terminal and the second terminal are located in a first region on one side in the left-right direction with the part of the wire harness as reference, and
the first terminal and the second terminal are at different positions from each other in the up-down direction in the first region.

2. The electrical junction box according to claim 1, wherein
the first terminal has a first support portion that supports a plurality of the first electric wires arranged in the left-right direction,
the second terminal has a second support portion that supports a plurality of the second electric wires arranged in the up-down direction, and
the second support portion is located closer to the part of the wire harness in the left-right direction than the first support portion.

3. The electrical junction box according to claim 2, wherein
the first terminal has a first fixing portion that fixes the first support portion to the case,
the second terminal has a second fixing portion that fixes the second support portion to the case, and
the first fixing portion and the second fixing portion are at different positions from each other in the left-right direction in the first region.

4. The electrical junction box according to claim 1, wherein
when a direction perpendicular to the left-right direction and the up-down direction is defined as a front-rear direction,
the first terminal and the second terminal are at different positions from each other in the front-rear direction in the first region.

5. The electrical junction box according to claim 4, wherein
the case has a tray-shaped first case that is open on one side in the up-down direction, a first bolt and a second bolt protruding from the first case to the one side in the up-down direction, and a first nut and a second nut respectively fastened to the first bolt and the second bolt, and
the first terminal and the second terminal are respectively fixed to the first case by the first nut and the second nut.

6. The electrical junction box according to claim 1, comprising an attachment member that supports at least one electric wire of the first electric wire and the second electric wire, and allows the one electric wire to be routed along a wall of the case.

7. The electrical junction box according to claim 2, wherein
when a direction perpendicular to the left-right direction and the up-down direction is defined as a front-rear direction,
the first terminal and the second terminal are at different positions from each other in the front-rear direction in the first region.

8. The electrical junction box according to claim 3, wherein
when a direction perpendicular to the left-right direction and the up-down direction is defined as a front-rear direction,
the first terminal and the second terminal are at different positions from each other in the front-rear direction in the first region.

9. The electrical junction box according to claim 2, comprising an attachment member that supports at least one electric wire of the first electric wire and the second electric wire, and allows the one electric wire to be routed along a wall of the case.

10. The electrical junction box according to claim 3, comprising an attachment member that supports at least one electric wire of the first electric wire and the second electric wire, and allows the one electric wire to be routed along a wall of the case.
